(19) United States
(12) Patent Application Publication
(10) Pub. No.: US 2015/0159750 A1
(43) Pub. Date: Jun. 11, 2015

(54) SHIFTING LEVER DEVICE FOR ACTUATING A VEHICLE GEARBOX

(71) Applicant: ZF Friedrichshafen AG, Friedrichshafen (DE)

(72) Inventors: Ludger Rake, Steinfeld (DE); Andreas Giefer, Lemfoerde (DE); Ralf Hartrampf, Wagenfeld (DE)

(73) Assignee: ZF Friedrichshafen AG a corporation

(21) Appl. No.: 14/411,867

(22) PCT Filed: Mar. 14, 2013
(86) PCT No.: PCT/EP2013/059883

§ 371 Date: Dec. 29, 2014

(30) Foreign Application Priority Data
Jun. 29, 2012 (DE) 10 2012 211 309.6

(51) Int. Cl. F16H 61/22; F16H 59/10

(52) U.S. Cl. CPC F16H 61/22; F16H 59/105; F16H 2061/223

(57) ABSTRACT

A gearshift lever assembly for actuating a vehicle transmission, having a mounting, a gearshift lever moveably supported on the mounting and which can be moved to predefined gearshift lever positions, a blocking device that can be moved to predefined blocking device positions, in which the gearshift lever can be locked to the mounting in a first gearshift lever position by means of the blocking device, a release mechanism, comprising a switch that responds to magnetic fields and a magnet, the spacing of which to one another can be varied by moving the blocking device such that, in the first gearshift lever position, the switch can be activated by the magnetic field of the magnet when the blocking device is in a first blocking device position, and at least one shielding element between the magnet and the switch can be placed in a positioned and removed from this position, by means of which the switch can be shielded from the magnetic field of the magnet in at least one other gearshift lever position of the predefined gearshift lever positions of the gearshift lever.

The invention relates to a gearshift lever assembly for actuating a vehicle transmission, having a mounting, a gearshift lever, moveably supported on the mounting, and which can be moved to predefined gearshift lever positions, which comprise a first gearshift lever position, a blocking device that can be moved to predefined blocking device positions, which comprise a first blocking device position in which the gearshift lever can be locked to the mounting in the first gearshift lever position by means of the blocking device, and a release mechanism, which comprises a switch that responds to magnetic fields and a magnet as components, the spacing to one another of which can be varied by moving the blocking device, such that in the first gearshift lever position of the gearshift lever, the switch can be activated by the magnetic field of the magnet when the blocking device is in the first blocking device position.

Gearshift lever assemblies of this type comprise, in the case of an automatic transmission, e.g. the gearshift lever positions P, R, N and D, wherein P designates a parking state, R designates a reverse drive operation, N designates a neutral state, and D designates a forward drive operation. The ignition lock of the vehicle normally comprises an ignition key locking mechanism, by means of which the ignition key can be locked in the ignition lock, such that a removal of the ignition key from the ignition can be prevented in specific gearshift lever positions. In order to release the ignition key such that it can be removed, when the gearshift lever is in the locked state in the gearshift lever position P, a magnetic switch, designed as a reed contact switch, which is coupled to the ignition key lock, is activated via the approach of a permanent magnet in the locking mechanism, such that the ignition key lock releases the ignition key so that it can be removed. Because a locking of the gearshift lever is also possible, however, in the gearshift lever position N, the permanent magnet in this gearshift lever position can likewise be in a position in which the reed contact is activated. This results in the ignition key being able to be removed when the gearshift lever is in the gearshift lever position N, which is undesired.

Until now, in order to solve this problem, the current switching state of the reed contact has been logically linked electronically with the current gearshift lever position of the gearshift lever, such that a release of the ignition key only occurs then, when the reed contact is established, and the gearshift lever is in the gearshift lever position P. This solution, however, is associated with the disadvantage that at the point in time at which this linkage is to occur, there is frequently no voltage supply available for executing the linkage. Alternatively, the desired functionality can also be obtained by additional mechanical elements, e.g. a lever. This however, results in a higher force expenditure being required for actuating the blocking device, resulting in an increased current consumption, and a larger spatial requirement for the controlling equipment, by means of which the blocking device can be moved.

Based on this, the invention addresses the objective of further developing a gearshift lever assembly of the type specified in the introduction, such that the portrayed problem can be solved without increasing the force expenditure for actuating the blocking device, and without needing to logically link, in an electronic manner, the current gearshift lever position of the gearshift lever with the current switching state of the switch.

This objective is achieved by a gearshift lever assembly according to Claim 1. Preferred further developments of the gearshift lever assembly are defined in the dependent claims and in the following description.

The gearshift lever assembly for actuating a vehicle transmission has a mounting, a gearshift lever moveably supported on the mounting and which can be moved to predefined gearshift lever positions, which comprise a first gearshift lever position, a blocking device that can be moved to predefined blocking device positions, which comprise a first blocking device position in which the gearshift lever can be locked to the mounting in the first gearshift lever position by means of the blocking device, a release mechanism, which comprises a switch that responds to magnetic fields and a magnet as components, the spacing to one another of which can be varied by moving the blocking device, such that in the first gearshift lever position of the gearshift lever, the switch can be activated by the magnetic field of the magnet when the blocking device is in the first blocking device position, and at least one shielding element between the magnet and the switch, which can be positioned and can be removed from this position, at least manually or automatically, by means of which, in particular when the blocking device is in the first blocking device position, the switch can be shielded from the magnetic field of the magnet in at least one other, or in each of the other gearshift lever positions of the predefined gearshift lever positions of the gearshift lever.

By means of the shielding element it is possible in a simple manner to prevent an activation of the switch, in that the shielding element is positioned between the magnet and the switch. This is the case, in particular, for the first blocking device position of the blocking device, because the magnet itself can then no longer interact magnetically with the switch when it is positioned in close spatial proximity thereto. For this, no additional levers are necessary, which would increase the force expenditure for actuating the blocking device. Moreover, no electronic linking of the current gearshift lever position to the current switching state of the switch is necessary.

Furthermore, it is possible in a simple manner to again enable an activation of the switch, in that the shielding element can be moved out of the position between the magnet and the switch, and as a result, the magnetic field of the magnet is no longer shielded. This is the case in particular for the first blocking device position of the blocking device, at least in the first gearshift lever position of the gearshift lever, in order that the magnet can interact with the switch when it is positioned in close spatial proximity thereto. Preferably this is likewise the case for the first blocking device position of the blocking device in at least one of the other, or in all of the other, gearshift lever positions of the predefined gearshift lever positions. By this means, an activation of the switch in at least one or the other gearshift lever positions, in particular in the framework of an emergency release, in which an activation of the switch is necessary, can be released, or enabled, respectively.

Preferably the shielding element is mechanically coupled to the gearshift lever by means of pull cables or a rigid connection, or a similar means, such that the shielding element can be positioned between the magnet and the switch, and removed therefrom, by moving the gearshift lever. By way of example, the shielding element can be carried or moved from the first to another gearshift lever position by moving the gearshift lever, such that the shielding element is automatically positioned between the magnet and the switch in one of the other gearshift lever positions. By moving the gearshift lever into the first gearshift lever position, the shielding element can be automatically brought out of, or returned to, the position between the magnet and the switch, preferably into the original position.

Alternatively, or in addition thereto, the shielding element is preferably electronically coupled to the gearshift lever, such that the shielding element can be positioned between the magnet and the switch, or can be removed from this position, depending on the situation, by moving the gearshift lever from one gearshift lever position to another gearshift lever position, as described above. By way of example, the shielding element can be moved, or carried, via at least one actuator, which is electronically coupled to the gearshift lever such that the actuator positions the shielding element in relation to the switching movement, depending on the situation, between the magnet and the switch, or removes it from this position.

The preferred embodiments of the present invention described above show, in an exemplary manner, the fundamental principle of these preferred embodiments, that the at least one shielding element, in particular in the manner suited to the situation, can be automatically positioned between the magnet and the switch, in one or more gearshift lever positions, by moving, or in relation to a movement of, respectively, the gearshift lever, and can automatically be removed from this position.

Furthermore, it is preferred that the shielding element, alternatively or in addition thereto, can be positioned manually between the magnet and the switch, and can be manually removed from this position. By way of example, the shielding element can be coupled mechanically or electronically, as described above, by way of example, to an actuating device, such as an emergency release mechanism, for example. The shielding element can be moved into at least one of the positions described above by means of the actuating device, controlled by a user, or manually, thus independently of a gearshift lever movement. This can then be necessary, for example, if the shielding element does not move automatically into one of the positions allocated to the respective gearshift lever position. This could then be the case, for example, if the gearshift lever is located in a position other than the first gearshift lever position, and cannot be returned to the first gearshift lever position, by means of which an activation of the switch could be necessary in the other gearshift lever position. It is also conceivable that the shielding element, preferably in the first gearshift lever position, is to be removed manually from the position between the magnet and the switch.

The shielding element preferably consists of magnetic materials, in particular a ferromagnetic material, which is preferably distinguished by a high degree of magnetic permeability and a low degree of magnetic retention. The shielding element can also be referred to as a magnetic shielding element. In particular, the shielding element is designed as a plate. By way of example, the shielding element is provided on the mounting, and/or connected thereto in a fixed, in particular rigid, manner. Preferably the shielding element is provided, instead, on the gearshift lever, and/or connected thereto in a fixed, in particular rigid, manner. In particular, the shielding element can be moved by means of the gearshift lever in relation to the mounting.

The blocking device can preferably be moved into two predefined blocking device positions, comprising the first blocking device position and a second blocking device position, in which the gearshift lever in the first gearshift lever position, in particular, is not locked in position with the mounting. In the second blocking device, in particular, a change in the gearshift lever position from the first gearshift lever position is not prevented by the blocking device. In particular, the switch cannot be activated by the magnetic field of the magnet when the blocking device is in the second blocking device position. Preferably the magnet, when the blocking device is in the second blocking device position, exhibits a large spacing to the switch, such that the magnetic field at the switch is too weak to activate the switch. In the first blocking device position, the switch can preferably always be activated by the magnetic field of the magnet, as long as the switch is not shielded from the magnetic field of the magnet by the shielding element. Preferably the magnet exhibits a limited spacing to the switch, when the blocking device is in the first blocking device position, such that the switch is activated by the magnetic field of the magnet, as long as the shielding element is not disposed between the switch and the magnet.

According to a preferred design, the gearshift lever positions comprise at least one or more lockable gearshift lever positions, which comprise, in particular, the first gearshift lever position. By way of example, the one, or the at least one, lockable gearshift lever position is formed by the first gearshift lever position. Preferably, in each of the lockable gearshift lever positions, the gearshift lever can be locked to the mounting by means of the blocking device. The other, or at least one of the other, gearshift lever positions is, or comprises, preferably the, or one of the, lockable gearshift lever positions.

Preferably one, at least one, or numerous, locking recesses are provided, wherein the blocking element can be inserted into each of the locking recesses. In particular, one of the locking recesses is allocated to each of the lockable gearshift lever positions. In a locked blocking device position, the blocking device is, in particular, inserted in one of the locking recesses. In a released blocking device position, the blocking device is, in particular, not inserted in any of the locking recesses. The locking recesses are provided, by way of example, in the mounting, or in a body connected thereto in a fixed, in particular rigid, manner. Preferably the locking recesses are provided, however, in the gearshift lever, or in a locking body connected to the gearshift lever such that it moves together therewith, and/or connected to the gearshift lever in a fixed, in particular rigid, manner, and/or designed as an integral part thereof. By way of example, the gearshift lever is moveably supported on the mounting by means of the locking body. The locking recesses can lie on different sides of the blocking device. By this means it is possible, for example, to lock the gearshift lever in one, or at least one, of the other gearshift lever positions, when the blocking device is in the second blocking device position.

According to a preferred development, a positioning mechanism is provided, by means of which the blocking device can be moved to the different blocking device positions, back and forth between the blocking device positions, for example. Preferably the blocking device can be moved into the first blocking device position and the second blocking device position by means of the positioning mechanism. Preferably the positioning mechanism can be actuated electrically. In particular, the positioning mechanism comprises an electromagnet, by means of which the blocking device can be moved, which, for this purpose consists, preferably, at least in part, of magnetic materials, or is mechanically coupled to an actuator consisting, at least in part, of magnetic materials. Advantageously, the blocking device lies in the electromagnets such that it can be displaced. The blocking device thus forms an anchor or push rod lying in the electromagnet. By way of example, the blocking device can move on or in the positioning mechanism, in particular in a sliding manner, guided, and/or supported therein. Advantageously the blocking device is spring-loaded in the first blocking device position by means of a spring. This has the advantage that, in the event of a power failure and/or a current-less state of the electromagnets, the gearshift lever is automatically locked, as soon as it assumes the first gearshift lever position. In particular, the positioning mechanism is at least partially removed from the electromagnet when the blocking device is in the first blocking device position, preferably by means of a spring. By providing the electromagnet with a current, the blocking device can be moved into the second blocking device position, in particular against the force of the spring. Advantageously the blocking device is pulled, thereby, into the electromagnet, and/or pushed out of the electromagnet on the opposite side thereof. The positioning mechanism, together with the blocking device, preferably forms an attracting magnet. Preferably the positioning mechanism comprises a spring.

The blocking device can be provided on the gearshift lever and/or be moveably supported thereon, preferably with the positioning mechanism disposed therebetween, or supported by the positioning mechanism. Preferably, however, the blocking device is provided on the mounting, and/or moveably supported thereon, preferably with the positioning mechanism disposed therebetween, or supported by the positioning mechanism. The positioning mechanism can be provided on the gearshift lever and/or connected thereto in a fixed, in particular rigid, manner. Preferably, however, the positioning mechanism is provided on the mounting, and/or connected thereto in a fixed, in particular rigid, manner. By this means it is possible to avoid the connecting of electric supply and/or control lines to the positioning mechanism via moving parts.

The release mechanism can be provided on the gearshift lever and/or connected thereto in a fixed manner. Preferably, however, the release mechanism is provided on the mounting and/or connected thereto in a fixed manner. The switch can be provided on the blocking device, and/or connected thereto in a fixed, in particular rigid, manner. Preferably, however, the switch is provided on the mounting, and/or connected thereto in a fixed, in particular rigid, manner. By this means it is possible to avoid connecting the switch with electric lines via moving parts. Preferably the switch can only be activated by the magnetic field of the magnet, such that, in particular, no current supply is required for activating the switch. In particular, the switch is designed as a reed contact. The magnet can be provided on the mounting, and/or connected thereto in a fixed, in particular rigid, manner. Preferably, however, the magnet is provided on the blocking device, and/or connected thereto in a fixed, in particular rigid, manner. By way of example, the magnet is disposed on or in the region of a front side of the blocking device, which faces, in particular, toward the switch. Moreover, the blocking device can form the magnet. In particular, the magnet is designed as a permanent magnet. This offers the advantage that no electric lines for the magnet are necessary.

The switch can be engaged when it is not subjected to a magnetic field. In this case, the expression “activated” means that the switch is disengaged by the magnetic field of the magnet. Preferably, however, the switch is disengaged when not subjected to the magnetic field, such that the expression “activated” means that the switch is engaged by the magnetic field of the magnet. Alternatively, it is possible that the switch is selectively engaged or disengaged when not subjected to the magnetic field, and is switched over by the magnetic field of the magnet.

According to a preferred development, the shielding element can be positioned between the magnet and the switch, in particular by moving the gearshift lever, in numerous gearshift lever positions, in particular in numerous of the lockable gearshift positions. Preferably, in these gearshift lever positions of the gearshift lever, in particular in these lockable gearshift lever positions of the gearshift lever, the switch can be shielded from the magnetic field of the magnet by means of the shielding element. Advantageously these numerous gearshift lever positions form or comprise numerous of the lockable gearshift lever positions.

Preferably the shielding element is formed continuously over numerous of the gearshift lever positions. Furthermore, it is possible to provide numerous shielding elements, each of which are allocated to one or more of the gearshift lever positions in which the switch is to be shielded from the magnetic field of the magnet. In particular, by moving the gearshift lever, each of the shielding elements can be positioned between the magnet and the switch in the respective allocated gearshift lever position(s) of the gearshift lever. By way of example, the allocated gearshift lever position(s) is or are lockable gearshift lever positions. The shielding elements can be rigidly connected to one another, and/or have fixed locations in relation to one another.

Preferably the switch can be activated by the magnetic field of the magnet, when the blocking device is in the first blocking device position, if the gearshift lever is in the first gearshift lever position. In particular, in the first gearshift lever position of the gearshift lever, the switch is not shielded from the magnetic field by the shielding element when the blocking device is in the first blocking device position. The first gearshift lever position preferably forms an end position with respect to the movement path of the gearshift lever. In particular, the shielding element is designed, and/or disposed, such that it is not positioned between the magnet and the switch when the gearshift lever is in the first gearshift lever position. By this means it is possible, in the first gearshift lever position of the gearshift lever, to activate the switch by the magnetic field of the magnet when the blocking device is in the first blocking device position. Advantageously, the shielding element is designed, and/or disposed, such that it is positioned between the magnet and the switch in one of the gearshift lever positions adjacent to the first gearshift lever position of the gearshift lever.

Preferably the switch can be activated in numerous of the gearshift lever positions of the gearshift lever by the magnetic field of the magnet when the blocking device is in the first blocking device position. By way of example, these gearshift lever positions each form one of the lockable gearshift lever positions. In particular, in these gearshift lever positions of the gearshift lever, the switch cannot be shielded from the magnetic field of the magnet by the shielding element. These numerous gearshift lever positions comprise, in particular, the first gearshift lever position. Thus, it is possible to release the ignition key for removal in numerous of the gearshift lever positions.

According to one preferred design, the shielding element comprises at least one region through which the magnetic field of the magnet can pass, which is allocated, in particular, to one of the gearshift lever positions. By this means it is possible, when the gearshift lever is in this gearshift lever position, to activate the switch by means of the magnetic field of the magnet when the blocking device is in the first blocking device position. This is useful, in particular, if this gearshift lever position does not form an end position with respect to the movement path of the gearshift lever. By way of example, this gearshift lever position is formed by one of the lockable gearshift lever positions. Advantageously, the region through which the magnetic field of the magnet can pass is designed as a through hole provided in the shielding element.

The region of the shielding element through which the magnetic field of the magnet can pass can be allocated to the first gearshift lever position. Preferably, however, the region of the shielding element through which the magnetic field of the magnet can pass is allocated to another gearshift lever position. By way of example, the other gearshift lever position is formed by one of the lockable gearshift lever positions. Advantageously, the other gearshift lever position does not form an end position with respect to the movement path of the gearshift lever. In particular, the other gearshift lever position is provided in addition to the first gearshift lever position. By this means it is possible to activate the switch in numerous of the gearshift lever positions of the gearshift lever by means of the magnetic field of the magnet when the blocking device is in the first blocking device position.

Preferably the gearshift lever positions comprise at least one non-lockable gearshift lever position, in which the gearshift lever cannot be locked to the mounting by means of the blocking device. In particular, the gearshift lever positions comprise numerous non-lockable gearshift positions, in which the gearshift lever cannot be locked to the mounting by means of the blocking device. The one, or at least one of the, non-lockable gearshift lever positions can be disposed between, or adjacent to, two of the lockable gearshift lever positions. Preferably, the shielding element can be positioned between the magnet and the switch, in particular by moving the gearshift lever, in one or more of the lockable gearshift lever positions and/or in one or more of the non-lockable gearshift lever positions. Moreover, the shielding element can be designed such that it is continuous over numerous of the gearshift lever positions, thus offering advantages with regard to the manufacturing thereof.

According to one preferred development, an ignition lock having an ignition key locking mechanism is provided, which can be released by means of the release mechanism. The release mechanism can thus also be referred to as an ignition key release mechanism. The ignition lock and/or the ignition key locking mechanism is coupled, in particular, to the release mechanism, preferably coupled electrically. Preferably the ignition key locking mechanism is released when the switch is activated by the magnetic field of the magnet. In particular, an ignition key can be locked into the ignition lock by means of the ignition key locking mechanism. In a locked state of the ignition key locking mechanism, the ignition key is locked into the ignition lock. In a released state of the ignition key locking mechanism, the ignition key can be removed from the ignition lock.

The gearshift lever can be moved to the different gearshift lever positions, in particular by manual actuation thereof. Preferably the gearshift lever is supported on the mounting such that it can be slid or pivoted. The moveable support of the gearshift lever on the mounting can be obtained in a direct or indirect manner. Preferably the gearshift lever is connected to the body in a fixed, in particular rigid, manner, by means of which the gearshift lever is moveably supported on the mounting. Preferably, the body forms the locking body. If the gearshift lever can be slid in relation to the mounting, the body preferably forms a sled, which is supported on the mounting, in particular, such that it can be slid.

The gearshift lever assembly, in particular the gearshift lever, is preferably coupled to the, or a, vehicle transmission and/or to a transmission control device for the transmission. This coupling is either mechanical or electronic, for example. Preferably the transmission and/or the transmission control device can be actuated by means of the gearshift lever assembly, in particular by means of the gearshift lever. The transmission is, in particular, an automatic transmission.

The invention furthermore relates to a motor vehicle having the vehicle transmission and the gearshift lever assembly. Advantageously, the vehicle also comprises the ignition lock. In particular, the vehicle comprises a vehicle body, to which the mounting is connected in a fixed, in particular rigid, manner. The vehicle concerns, in particular, an automobile.

The invention shall be described below based on a preferred embodiment, with reference to the drawings. Shown in the drawings are:

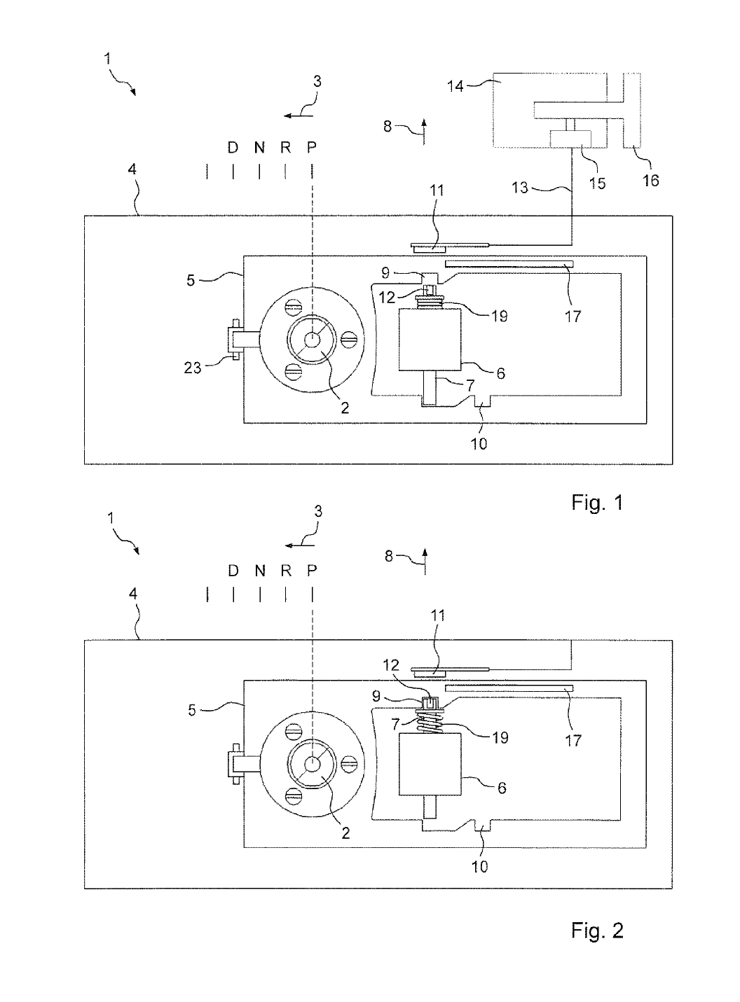

FIG. 1 a schematic view from above of a gearshift lever assembly according to one embodiment, wherein the gearshift lever is placed in a lockable gearshift lever position, but is not locked,

FIG. 2 the view from above according to FIG. 1, wherein the gearshift lever is locked,

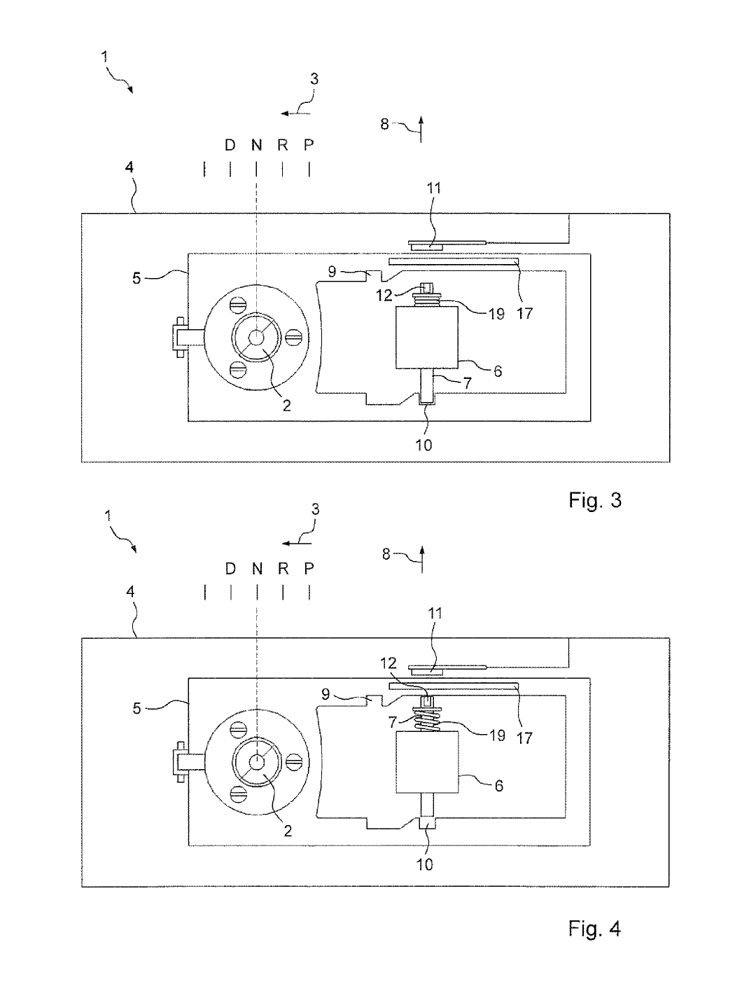

FIG. 3 a schematic view from above of the gearshift lever assembly according to the embodiment, wherein the gearshift lever is placed in another lockable gearshift lever position, and is locked therein,

FIG. 4 the view from above according to FIG. 3, wherein the gearshift lever is not locked,

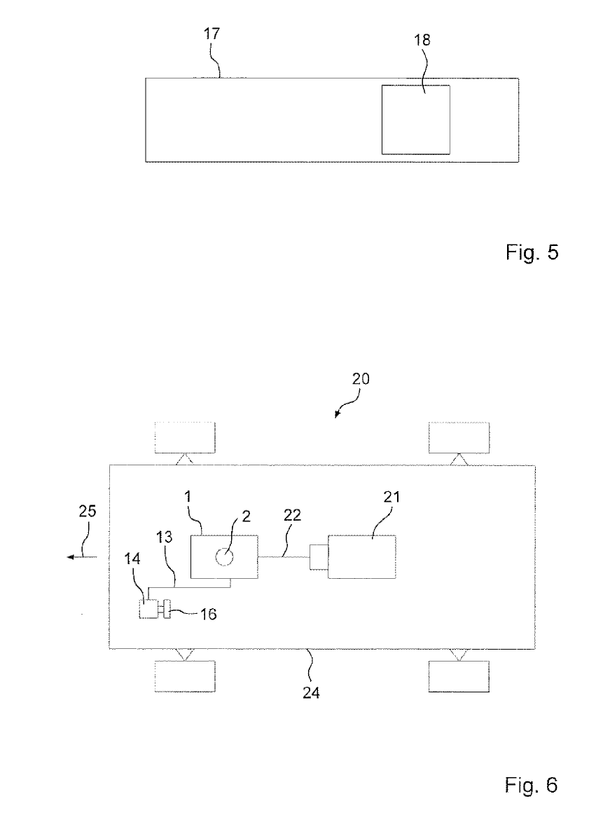

FIG. 5 a schematic depiction of a shielding element according to a variation of the embodiment, and

FIG. 6 a schematic view from above of a motor vehicle, which has the gearshift lever assembly according to the embodiment.

In FIGS. 1-4, different depictions of a gearshift lever assembly 1 according to one embodiment are illustrated, wherein the gearshift lever 2 can be moved in a shifting direction 3, in particular in a sliding or pivoting manner, supported on a mounting 4, and can be moved in relation thereto to predefined gearshift lever positions P, R, N, and D. According to FIGS. 1 and 2, the gearshift lever 2 is placed in the gearshift position P. The gearshift lever 2 is connected rigidly to a body 5, and is supported on the mounting 4 such that it can be moved by means of this body in the shifting direction 3. The body 4 forms a carrier (carrier body) thereby for the gearshift lever 2, and is preferably screwed to it. It is, however, also possible to connect the gearshift lever 2 to the body 5 by other means, or to design the body 5 and the gearshift lever 2 as an integrated unit. Furthermore, it is possible to support the gearshift lever 2 on the mounting 4 such that it can move independently of the body 5. Preferably, however, the body 5 is connected such that it moves together with the gearshift lever 2. If the gearshift lever 2 can slide in relation to the mounting 4, the body 5 is then designed as a sled, for example, which is supported such that it can slide on the mounting 4 in the shifting direction 3.

A positioning mechanism 6 in the form of an electromagnet is rigidly attached to the mounting 4, in which a blocking device 7 is located such that it can slide in a blocking direction 8, which consists in part of ferromagnetic materials, and thus forms a moveable anchor for the electromagnet 6. The blocking direction 8 runs, in particular, transverse to the shifting direction 3. The blocking device 7 is spring-loaded in the blocking direction 8 by means of a spring 19, and is retained by the magnetic force of the electromagnet 6, when subjected to current, against the force of the spring 19, in its position, illustrated in FIG. 1, which is referred to as the second blocking device position. The positioning mechanism 6, together with the blocking device 7, forms, in particular, an attracting magnet. When the electromagnet is not subjected to a current, the spring 19 forces the blocking device 7 into a first blocking device position, which can be seen in FIG. 2.

A locking recess 9 is provided in the body 5, into which the blocking device 7 can engage, when the electromagnet 6 is not subjected to a current, in the gearshift lever position P for the gearshift lever 2. If the blocking device 7 is engaged in the locking recess 9, the gearshift lever 2 is locked to the mounting 4, as can be seen in FIG. 2. The gearshift lever position P thus forms a lockable gearshift lever position for the gearshift lever 2. Furthermore, the body 5 has at least one second locking recess 10, which is allocated to the gearshift lever position N. In the region of the locking recess 9, the body 5 runs between the positioning mechanism 6 and a switch 11, designed as a reed contact magnetic switch, which is rigidly attached to the mounting 4. Furthermore, a permanent magnet 12 is disposed in a front-side end region of the blocking device 7, facing the switch 11, and is rigidly attached to the blocking device 7. In the locked blocking device position of the blocking device 7, illustrated in FIG. 2, the magnet 12 is brought in the proximity of the switch 11, such that the switch is subjected to a quantity of the magnetic field from the magnet 12 sufficient for activating the switch, and thus activates the switch, i.e. the switch becomes engaged. The switch 11 is connected, via electric lines 13, to an ignition lock 14, which comprises an ignition key locking mechanism, by means of which an ignition key 16 can be locked in the ignition lock 14. If the switch is disengaged, the ignition key 16 is locked in the ignition lock 14. If the switch 11 is engaged, however, then the ignition key locking mechanism 15 releases the ignition key 16, which can thus be removed from the ignition lock 14. The magnet 12 and the switch 11 form, together, an ignition key release mechanism, which can be actuated by means of the positioning mechanism 6 and/or the blocking device 7.

According to FIG. 3, the gearshift lever 2 is placed in the gearshift lever position N, in which the gearshift lever 2 is locked to the mounting 4, because the blocking device 7 is engaged in the locking recess 10. The gearshift lever position N thus forms a lockable gearshift lever position for the gearshift lever 2. In FIG. 4, the unlocked state of the gearshift lever 2 in the gearshift lever position N is illustrated, wherein the blocking device 7 is placed in the first blocking device position. According to FIG. 3, the blocking device 7 is placed, however, in the second blocking device position, such that the gearshift lever 2 is locked to the mounting 4.

In the gearshift lever position N, a shielding element 17 made of ferromagnetic material is disposed between the magnet 12 and the magnetic switch 11, designed as a plate, which shields the switch 11 from the magnetic field of the magnet 12. The gearshift lever 2 can thus be unlocked in the gearshift lever position N, without engaging the switch 11, such that the ignition key 16 cannot be removed from the ignition lock 14. The shielding element 17 is rigidly connected to the body 5, and is thus connected such that it can be moved together with gearshift lever 2.

In the gearshift lever positions R and D, the gearshift lever 2 cannot be locked to the mounting 4 by means of the blocking device 7. In particular, no locking recess in the body 5 is allocated to these gearshift lever positions. The gearshift lever positions R and D thus form non-lockable gearshift lever position for the gearshift lever 2. Alternatively, however, the gearshift lever 2 can also be lockable to the mounting 4 in the gearshift lever positions R and/or D, by means of the blocking device 7.

In FIG. 5, a variation of the shielding element 17 is illustrated, wherein a through hole 18 is provided therein, forming a region through which the magnetic field of the magnet 12 can pass, and to which another gearshift lever position is allocated. It is thus possible to remove the ignition key 16 from the ignition lock 14 in the other gearshift lever position when the blocking device 7 is placed in the first blocking device position.

In FIG. 6 a motor vehicle 20 is illustrated in a schematic view from above, having the gearshift lever assembly 1 and having a vehicle transmission 21 designed as an automatic transmission, which is connected to the body 5 via a pull cable 22. The body 5 also has a connection 23 (see FIG. 1), to which the pull cable 22 is attached. The transmission 21 can thus be actuated by moving the gearshift lever 2. Alternatively, the current gearshift lever position of the gearshift lever 2 can also be detected by means of scanning electronics in the gearshift lever assembly 1. In this case, the transmission 21 is connected to the scanning electronics via electric lines. The vehicle 20 comprises a vehicle body 24, on which the mounting 4 is rigidly attached. Furthermore, the conventional forward driving direction of the vehicle 20 is depicted, and indicated with the reference symbol 25.

### REFERENCE SYMBOLS

1 gearshift lever assembly
2 gearshift lever
3 shifting direction
4 mounting
5 body
6 positioning mechanism/electromagnet
7 blocking device
8 blocking direction
9 locking recess
10 locking recess
11 magnetic switch/reed contact
12 permanent magnet
13 electric line
14 ignition lock
15 ignition key locking mechanism
16 ignition key
17 shielding element
18 hole in shielding element
19 spring
20 motor vehicle
21 vehicle transmission
22 pull cable
23 connection for pull cable
24 vehicle body
25 forward driving direction of the vehicle

1. A gearshift lever assembly for actuating a vehicle transmission, the gearshift lever assembly comprising:
a mounting;
a gearshift lever moveably supported on the mounting and capable of moving between a first predefined gearshift lever position and a second predefined gearshift lever position;
a blocking device capable of moving to a first predefined blocking device position, wherein the blocking device locks the gearshift lever to the mounting when the gearshift lever is in the first predefined gearshift lever position and the blocking device is in the first predefined blocking device position;
a release mechanism comprising a magnetically responsive switch and a magnet, wherein the spacing between the magnetically responsive switch and the magnet can be varied by moving the blocking device, and when the gearshift lever is in the first gearshift lever position and the blocking device is in the first blocking device position, the magnetic field of the magnet can activate the magnetically responsive switch; and
a shielding element capable of being positioned between the magnet and the switch, wherein when the gearshift lever is in the second predefined gearshift lever position, the shielding element is positioned between the magnet and the switch and shields the magnetically responsive switch from the magnetic field of the magnet.

2. The gearshift lever assembly of claim 1, wherein the shielding element comprises a ferromagnetic material.

3. The gearshift lever assembly of claim 1, wherein the shielding element comprises a plate.

4. The gearshift lever assembly of claim 1, wherein the shielding element is connected to the gearshift lever and moves with the gearshift lever in relation to the mounting.

5. The gearshift lever assembly of claim 1, wherein the magnet is provided on the blocking device and the switch is provided on the mounting.

6. The gearshift lever assembly of claim 1, wherein the shielding element can be positioned between the magnet and the switch in a third predefined gearshift lever position.

7. The gearshift lever assembly of claim 1, wherein the shielding element comprises a region through which the magnetic field of the magnet can pass to activate the switch when the blocking device is in the first blocking device position.

8. The gearshift lever assembly of claim 1, further comprising a positioning mechanism capable of moving the blocking device from the first blocking device position to a second blocking device position.

9. The gearshift lever assembly of claim 8, wherein the blocking device is displaceably inserted into the positioning mechanism, wherein the positioning mechanism comprises an electromagnet and the blocking device comprises a magnetic material.

10. The gearshift lever assembly of claim 1, further comprising an ignition lock having an ignition key locking mechanism that is released by the release mechanism.
